(19) United States
(12) Patent Application Publication
(10) Pub. No.: US 2018/0261134 A1
(43) Pub. Date: Sep. 13, 2018

(54) THREE-DIMENSIONAL POP-UP DISPLAY

(71) Applicant: R.J. REYNOLDS TOBACCO COMPANY, Winston-Salem, NC (US)

(72) Inventors: Andries Sebastian, Clemmons, NC (US); Michael F. Davis, Clemmons, NC (US); Rajesh Sur, Winston-Salem, NC (US)

(21) Appl. No.: 15/455,249

(22) Filed: Mar. 10, 2017

(51) Int. Cl. G09F 1/06; B42D 15/02; B42D 15/04

(52) U.S. Cl. CPC G09F 1/06; B42D 15/042; B42D 15/022

(57) ABSTRACT

A three-dimensional (3D) pop-up display is provided. The 3D display comprises a folding panel formed of a paper substrate, and a power source. The folding panel comprises an interior surface with a pop-up element integral therewith. The pop-up element is located about a hinge of the folding panel and configured to form a 3D graphic about the hinge upon opening the folding panel. The pop-up element also comprises an electrical device printed or placed thereon. The electrical device includes at least one of a light source or a speaker. The power source is contained between the interior surface of the folding panel and the pop-up element and configured to power the electrical device.

### TECHNOLOGICAL FIELD

The present disclosure relates generally to three-dimensional (3D) pop-displays for marketing materials, and more particularly to 3D pop-up displays having electronics printed thereon.

### BACKGROUND

Various products are sold at retail stores that often carry a variety of products of different brands to attract a wider range of consumers and encourage multiple purchases from them. For example, convenience stores and supermarkets often carry a large variety of food, beverages, and other products. By way of further example, such stores also often carry tobacco products. Point-of-sale marketing materials are often provided to retailers by the manufacturers or distributors of the products. Product manufacturers, distributors, and retailers are often searching for improved methods and mechanisms for gaining a consumer's attention within retail environments and through other avenues for advertisement. Traditionally, paper displays including posters and postcards have been used for advertisement and marketing materials.

It may be desirable to develop more attractive displays for marketing materials, providing both visual and tactile attractiveness for consumers.

### BRIEF SUMMARY

The present disclosure relates to pop-up displays and printed electronics. The present disclosure thus includes, without limitation, the following example implementations. In some example implementations, a 3D pop-up display is provided. The 3D pop-up display may comprise a folding panel formed of a paper substrate and having an interior surface with a pop-up element integral therewith. The pop-up element is located about a hinge of the folding panel and configured to form a 3D graphic thereabout upon opening the folding panel. The pop-up element has an electrical device printed or placed thereon that includes at least one of a light source or a speaker, and a power source contained between the interior surface of the folding panel and the pop-up element, and configured to power the electrical device.

In some example implementations of the 3D pop-up display of the preceding or any subsequent example implementation, or any combination thereof, the folding panel is a multi-ply panel including a first ply and a second ply that define respectively an exterior surface and the interior surface of the folding panel, at least a portion of the second ply being separable from the first ply and forming the 3D graphic upon opening the folding panel.

In some example implementations of the 3D pop-up display of any preceding or any subsequent example implementation, or any combination thereof, a flex sensor affixed to the interior surface of the folding panel and configured to detect flexion of the folding panel about the hinge, and generate an activation signal in response thereto, and a control component configured to receive the activation signal and activate the electrical device in response thereto.

In some example implementations of the 3D pop-up display of any preceding or any subsequent example implementation, or any combination thereof, the flex sensor being configured to generate the activation signal includes being configured to generate the activation signal only in instances in which the flexion of the folding panel about the hinge is at least 90 degrees.

In some example implementations of the 3D pop-up display of any preceding or any subsequent example implementation, or any combination thereof, the electrical device includes the light source, and the control component being configured to activate the electrical device includes being configured to control the light source to produce a sequence of lights.

In some example implementations of the 3D pop-up display of any preceding or any subsequent example implementation, or any combination thereof, the electrical device includes the speaker, and the control component being configured to activate the electrical device includes being configured to control the speaker to produce an audio signal.

In some example implementations of the 3D pop-up display of any preceding or any subsequent example implementation, or any combination thereof, the speaker includes at least one conductive organic polymer and a piezoactive layer.

In some example implementations of the 3D pop-up display of any preceding or any subsequent example implementation, or any combination thereof, the power source includes a thin-film solid state battery printed or placed on the interior surface of the folding panel.

In some example implementations of the 3D pop-up display of any preceding or any subsequent example implementation, or any combination thereof, the rechargeable thin-film solid state battery has a thickness no greater one-hundred micrometers.

In some example implementations of the 3D pop-up display of any preceding or any subsequent example implementation, or any combination thereof, the thin-film solid state battery has at least two current collectors, two electrodes and an electrolyte.

In some example implementations, a method is provided for controlling a 3D pop-up display. The method may comprise providing the 3D pop-up display comprising a folding panel formed of a paper substrate and having an interior surface with a pop-up element integral therewith. The pop-up element is located about a hinge of the folding panel and configured to form a 3D graphic thereabout upon opening the folding panel. The pop-up element has an electrical device printed or placed thereon, and the electrical device includes at least one of a light source or a speaker, and powering the electrical device using a power source contained between the interior surface of the folding panel and the pop-up element.

In some example implementations of the method of the preceding or any subsequent example implementation, or any combination thereof, the folding panel is a multi-ply panel including a first ply and a second ply that define respectively an exterior surface and the interior surface of the folding panel, at least a portion of the second ply being separable from the first ply and forming the 3D graphic upon opening the folding panel.

In some example implementations of the method of any preceding or any subsequent example implementation, or any combination thereof, the 3D display further comprises a flex sensor affixed to the interior surface of the folding panel and a control component, the method further comprises using the flex sensor, detecting flexion of the folding panel about the hinge and generating an activation signal in response thereto; and using the control component, and receiving the activation signal and activating the electrical device in response thereto.

In some example implementations of the method of any preceding or any subsequent example implementation, or any combination thereof, the flex sensor being configured to generate the activation signal includes being configured to generate the activation signal only in instances in which the flexion of the folding panel about the hinge is at least 90 degrees.

In some example implementations of the method of any preceding or any subsequent example implementation, or any combination thereof, the electrical device includes the light source, and activating the electrical device includes controlling the light source to produce a sequence of lights, using the control component.

In some example implementations of the method of any preceding or any subsequent example implementation, or any combination thereof, the electrical device includes the speaker, and activating the electrical device includes controlling the speaker to produce an audio signal, using the control component.

In some example implementations of the method of any preceding or any subsequent example implementation, or any combination thereof, the speaker includes at least one conductive organic polymer and a piezoactive layer.

In some example implementations of the method of any preceding or any subsequent example implementation, or any combination thereof, the power source includes a thin-film solid state battery printed or placed on the interior surface of the folding panel.

In some example implementations of the method of any preceding or any subsequent example implementation, or any combination thereof, the rechargeable thin-film solid state battery has a thickness no greater one-hundred micrometers.

In some example implementations of the method of any preceding or any subsequent example implementation, or any combination thereof, the thin-film solid state battery has at least two current collectors, two electrodes and an electrolyte.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described the disclosure in the foregoing general terms, reference will now be made to the accompanying drawings, which are not necessarily drawn to scale, and wherein:

FIG. 1 illustrates a three-dimensional (3D) pop-up display equipped with an electrical device, according to an example implementation of the present disclosure;

FIG. 2 illustrates the 3D pop-up display of FIG. 1, according to example implementations of the present disclosure;

FIGS. 3A and 3B illustrate a flex sensor of the 3D pop-up display of FIG. 1, according to example implementations of the present disclosure;

FIGS. 4 and 5 illustrate examples of a light source having a layered composition according to example implementations of the present disclosure; and

FIG. 6 illustrates various operations in a method for controlling a 3D pop-up display, according to an example implementation of the present disclosure.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, the singular forms “a,” “an,” “the” and the like include plural referents unless the context clearly dictates otherwise.

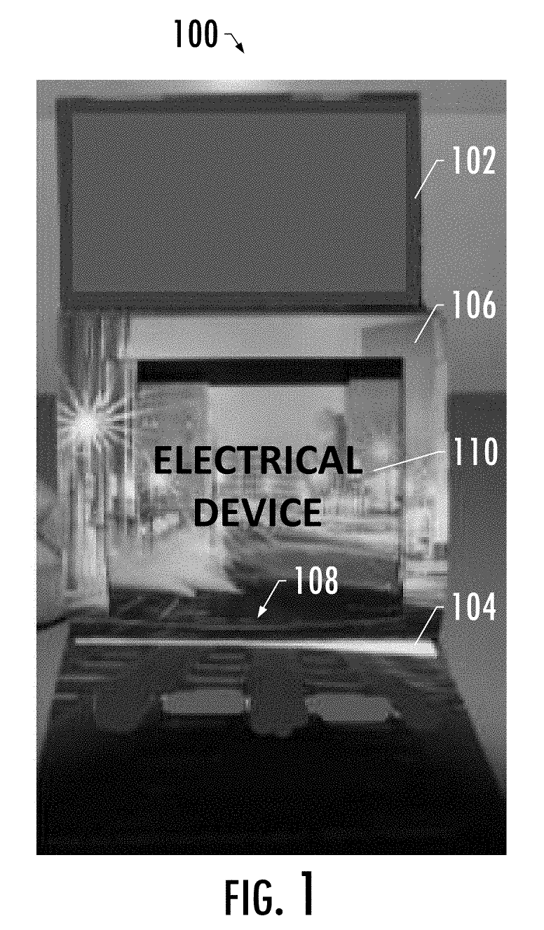

FIG. 1 illustrates a three-dimensional (3D) pop-up display 100 equipped with an electrical device, in an at least partially folded state, according to an example implementation of the present disclosure. Examples of suitable 3D pop-up displays are disclosed in U.S. Pat. No. 6,966,135 to McDonald; U.S. Pat. No. 7,111,736 to Petter; and U.S. Pat. No. 7,845,099 to Ross et al., the disclosures of which are incorporated herein by reference. For example, the 3D pop-up display may be used in advertising in the form of a marketing flyer. As shown, in some example implementations, the 3D pop-up display is or includes a light-illuminating 3D pop-up. The 3D pop-up display comprises a folding panel 102 formed of a paper substrate. The folding panel may have an interior surface 104 with a pop-up element 106 integral therewith. As shown, the pop-up element may be located about a hinge 108 of the folding panel and configured to form a 3D graphic thereabout upon opening the folding panel. The pop-up element may also have an electrical device 110 printed or placed thereon. For example, the electrical device may be printed directly on the exterior surface or a laminated on the exterior surface. In some examples, the electrical device may include at least one of a light source or a speaker.

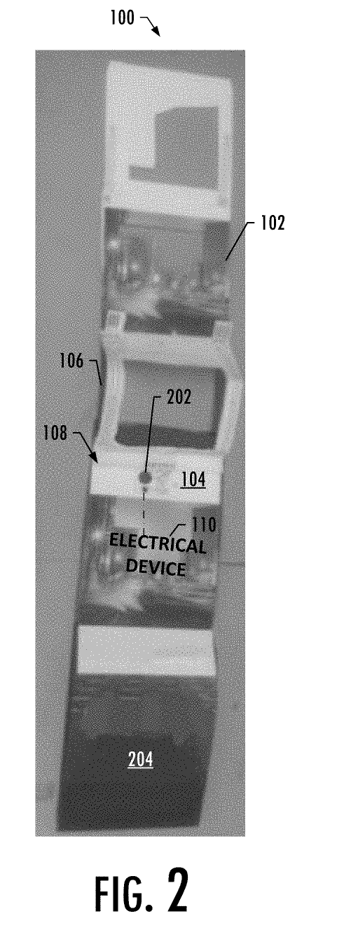

FIG. 2 more particularly illustrates the 3D pop-up display 100 of FIG. 1 in an unfolded state. As shown in FIG. 2, the 3D pop-up display may also comprise a power source 202 contained between the interior surface 104 of the folding panel 102 and the pop-up element 106. The power source may be configured to power the electrical device 110. This may be accomplished in any of a number of different manners. In some examples, the light source may include appropriate terminals configured to selectively connect the light source to the power source. In some examples, the power source itself may be a printed electrical device. That is, the power source may include a thin-film solid state battery printed or placed on the interior surface of the folding panel. In some implementations, the thin-film solid state battery may have a thickness no greater one-hundred micrometers. A suitable rechargeable thin film solid state battery may include a thin film solid state battery manufactured by STMicroelectronics. Further in some implementations, the thin-film solid state battery may comprise at least two current collectors, two electrodes and an electrolyte. In some examples, the power source is or includes power inverter configured to generate 60-120 volt alternating current having frequencies within a range of 50-1000 Hertz (Hz).

As also shown in FIG. 2, the folding panel 102 may include a multi-ply panel. More particularly, the folding panel may include a first ply that defines an exterior surface 204 of the folding panel, and a second ply that defines the interior surface 104 of the folding panel. In these examples, at least a portion of the second ply is separable from the first ply and forms the 3D graphic upon opening the folding panel.

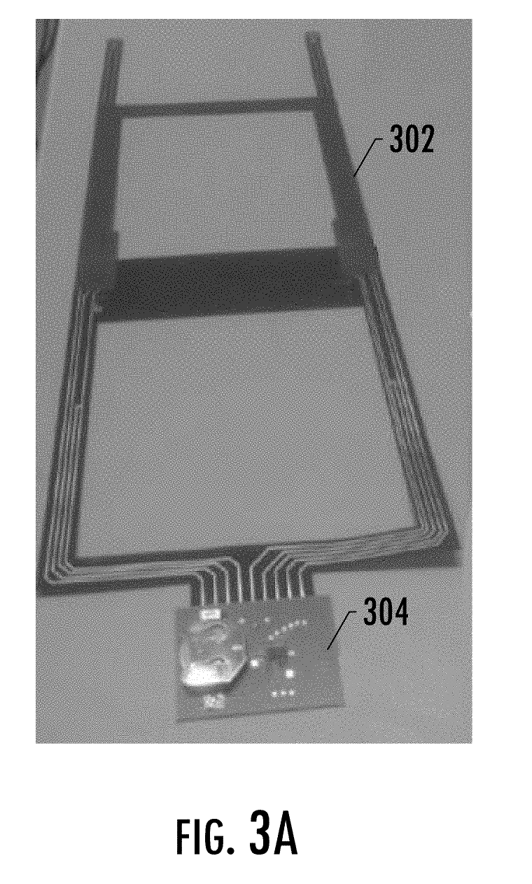

Now referring to FIGS. 3A and 3B, the 3D pop-up display 100 may also comprise a flex sensor 302 and a control component 304. FIG. 3A illustrates a suitable flex sensor operatively coupled to a control component. Examples of a suitable control component include one or more of each of a number of electronic components such as a microprocessor (individually or as part of a microcontroller), application-specific integrated circuit (ASIC), field-programmable gate array (FPGA) or the like. As shown in FIG. 3B, the flex sensor may be affixed to the interior surface 104 of the folding panel 102, and configured to detect flexion of the folding panel about the hinge 108 and generate an activation signal in response thereto. In some examples, the flex sensor is configured to generate the activation signal only in instances in which the flexion of the folding panel about the hinge is at least 90 degrees. The control component 304 may be configured to receive the activation signal and activate the electrical device 110 in response thereto.

As previously indicated, in some examples, the electrical device 110 includes a light source. In these examples, the control component 304 may be configured to activate the electrical device, and thereby control the light source to produce a sequence of lights upon activation and thereafter deactivate the light source. The light source of the electrical device may include an electroluminescent (EL), electrochromic (EC), light-emitting diode (LED), organic LED (OLED), or electrochemical cell (LEC) light source. In these examples, the light source may be configured to provide uniform surface illumination of complex shapes, low power consumption, and low heat generation, vibration and impact resistance. In some examples, the electrical device including an EL light source may comprise a capacitor structure having an inorganic phosphor (e.g., zinc sulfide compound) positioned between at least two electrodes.

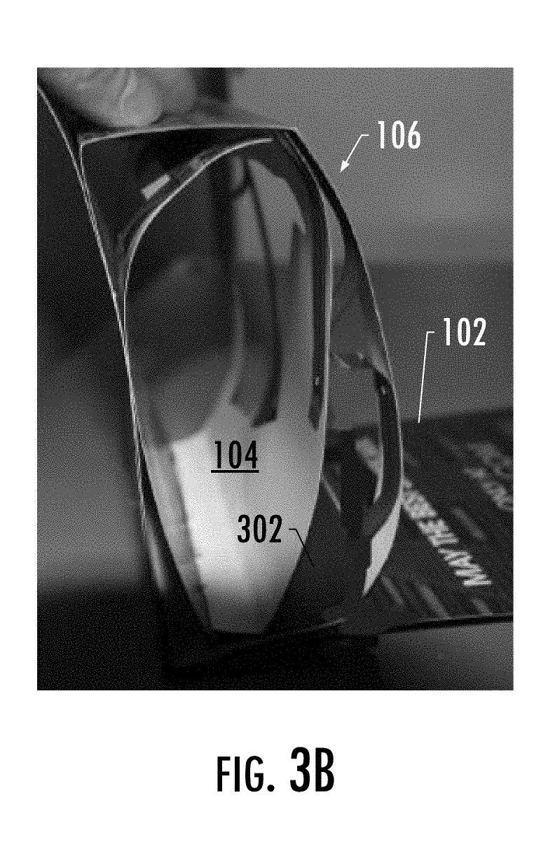

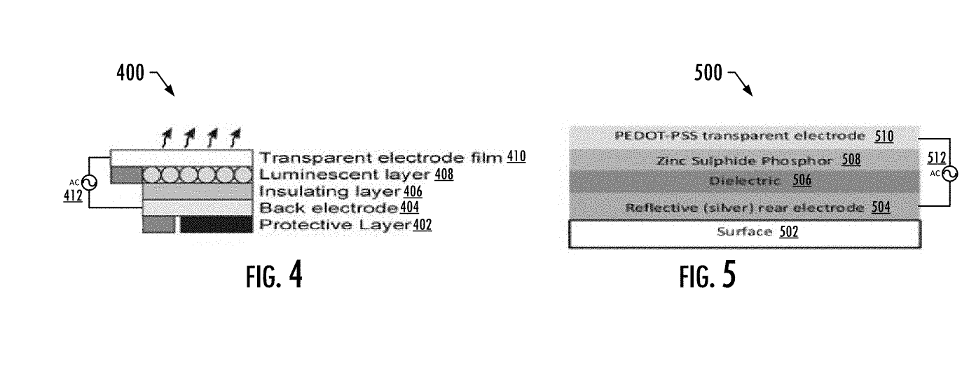

FIGS. 4 and 5 illustrate examples of suitable light sources that may be included as part of the electrical device 202, as described in U.S. patent application Ser. No. 15/097,019 to Sebastian et al., filed Apr. 12, 2016, which is incorporated herein by reference. More particularly, FIG. 4 illustrates a bottom light-emitting EL device 400, and FIG. 5 illustrates a top light-emitting EL device 500. As shown in FIG. 4, the bottom light-emitting device may include a suitable transparent substrate or protective layer 402, a back electrode 404 that may be or include a silver or carbon conductor, an insulating layer 406, a luminescent phosphor layer 408, a transparent front electrode 410 that may be or include a polyester film having an indium tin oxide (ITO) therein, and a protective layer (not shown). As shown in FIG. 5, the top light-emitting device may include a suitable surface layer 502, a reflective rear electrode 504, a dielectric layer 506, a luminescent phosphor layer 508 (e.g., zinc sulfide phosphor), a transparent electrode 510, and a protective layer (not shown).

In some examples, as shown in FIG. 4, light may be emitted through the transparent substrate such as the transparent electrode film 410. In alternate examples, as shown in FIG. 5, light may be emitted through a deposited back electrode, one example of which may be the semi-transparent conductive polymer (PEDOT-PSS) 510. As further shown in FIGS. 4 and 5, an alternating current (AC) voltage 412, 512 may be applied across the electrodes to generate a changing electric field within the phosphor particles and thereby cause an emittance of light by the particles. The bottom light-emitting EL device 400 may be suitable for use with transparent substrates such as a plastic film, and the top light-emitting EL device 500 may be suitable for use with opaque substrates such as paper.

In some examples, the electrical device 110 may include a speaker in addition to or in lieu of a light source. In these examples, the control component 304 may be configured to activate the electrical device, and control the speaker to produce an audio signal. The speaker may include at least one conductive organic polymer and a piezoactive layer.

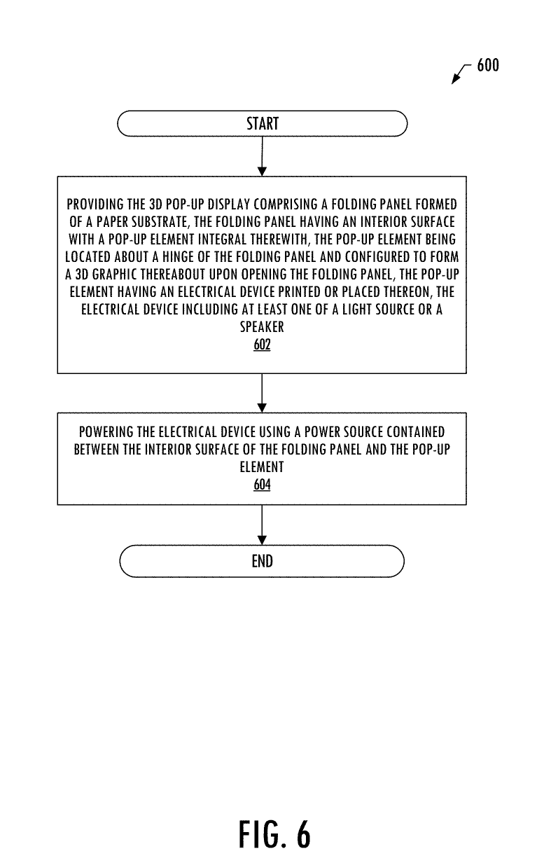

FIG. 6 illustrates various operations in a method 600 of controlling a 3D pop-up display according to an example implementation of the present disclosure. As shown in block 602, the method may include providing a 3D pop-up display comprising a folding panel formed of a paper substrate. The folding panel may have an interior surface with a pop-up element integral therewith. The pop-up element may be located about a hinge of the folding panel and configured to form a 3D graphic thereabout upon opening the folding panel. The pop-up element may have an electrical device printed or placed thereon. The electrical device may include at least one of a light source or a speaker. The method may also comprise powering the electrical device using a power source contained between the interior surface of the folding panel and the pop-up element, as shown at block 604.

The foregoing description of use of the article(s) may be applied to the various example implementations described herein through minor modifications, which may be apparent to the person of skill in the art in light of the further disclosure provided herein. The above description of use, however, is not intended to limit the use of the article but is provided to comply with all necessary requirements of disclosure of the present disclosure. Any of the elements shown in the article(s) illustrated in FIGS. 1-6 or as otherwise described above may be included in an aerosol delivery device according to the present disclosure.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A three-dimensional (3D) pop-up display comprising:
a folding panel formed of a paper substrate and having an interior surface with a pop-up element integral therewith, the pop-up element being located about a hinge of the folding panel and configured to form a 3D graphic thereabout upon opening the folding panel, the pop-up element having an electrical device printed or placed thereon, the electrical device including at least one of a light source or a speaker; and
a power source contained between the interior surface of the folding panel and the pop-up element, and configured to power the electrical device.

2. The 3D pop-up display of claim 1, wherein the folding panel is a multi-ply panel including a first ply and a second ply that define respectively an exterior surface and the interior surface of the folding panel, at least a portion of the second ply being separable from the first ply and forming the 3D graphic upon opening the folding panel.

3. The 3D pop-up display of claim 1 further comprising:
a flex sensor affixed to the interior surface of the folding panel and configured to detect flexion of the folding panel about the hinge, and generate an activation signal in response thereto; and
a control component configured to receive the activation signal and activate the electrical device in response thereto.

4. The 3D pop-up display of claim 3, wherein the flex sensor being configured to generate the activation signal includes being configured to generate the activation signal only in instances in which the flexion of the folding panel about the hinge is at least 90 degrees.

5. The 3D pop-up display of claim 3, wherein the electrical device includes the light source, and the control component being configured to activate the electrical device includes being configured to control the light source to produce a sequence of lights.

6. The 3D pop-up display of claim 3, wherein the electrical device includes the speaker, and the control component being configured to activate the electrical device includes being configured to control the speaker to produce an audio signal.

7. The 3D pop-up display of claim 6, wherein the speaker includes at least one conductive organic polymer and a piezoactive layer.

8. The 3D pop-up display of claim 1, wherein the power source includes a rechargeable thin-film solid state battery printed or placed on the interior surface of the folding panel.

9. The 3D pop-up display of claim 8, wherein the thin-film solid state battery has a thickness no greater one-hundred micrometers.

10. The 3D pop-up display of claim 8, wherein the thin-film solid state battery has at least two current collectors, two electrodes and an electrolyte.

11. A method for controlling a three-dimensional (3D) pop-up display, the method comprising:
providing the 3D pop-up display comprising a folding panel formed of a paper substrate and having an interior surface with a pop-up element integral therewith, the pop-up element being located about a hinge of the folding panel and configured to form a 3D graphic thereabout upon opening the folding panel, the pop-up element having an electrical device printed or placed thereon, the electrical device including at least one of a light source or a speaker; and
powering the electrical device using a power source contained between the interior surface of the folding panel and the pop-up element.

12. The method of claim 11, wherein the folding panel is a multi-ply panel including a first ply and a second ply that define respectively an exterior surface and the interior surface of the folding panel, at least a portion of the second ply being separable from the first ply and forming the 3D graphic upon opening the folding panel.

13. The method of claim 11, wherein the 3d display further comprises a flex sensor affixed to the interior surface of the folding panel and a control component, the method further comprising:
using the flex sensor, detecting flexion of the folding panel about the hinge and generating an activation signal in response thereto; and using the control component,
receiving the activation signal and activating the electrical device in response thereto.

14. The method of claim 13, wherein the flex sensor being configured to generate the activation signal includes being configured to generate the activation signal only in instances in which the flexion of the folding panel about the hinge is at least 90 degrees.

15. The method of claim 13, wherein the electrical device includes the light source, and activating the electrical device includes controlling the light source to produce a sequence of lights, using the control component.

16. The method of claim 13, wherein the electrical device includes the speaker, and activating the electrical device includes controlling the speaker to produce an audio signal, using the control component.

17. The method of claim 16, wherein the speaker includes at least one conductive organic polymer and a piezoactive layer.

18. The method of claim 11, wherein the power source includes a rechargeable thin-film solid state battery printed or placed on the interior surface of the folding panel.

19. The method of claim 18, wherein the thin-film solid state battery has a thickness no greater one-hundred micrometers.

20. The method of claim 18, wherein the thin-film solid state battery has at least two current collectors, two electrodes and an electrolyte.
